(19) United States
(12) Patent Application Publication
(10) Pub. No.: US 2005/0085965 A1
(43) Pub. Date: Apr. 21, 2005

(54) Programmable vehicle accessory features

(76) Inventors: Nabil M. Issa, Novi, MI (US); Laura A. Smith, Livonia, MI (US); Karen M. Strausbaugh, Clarkston, MI (US); Steven L. Clark, Birmingham, MI (US); James M. Witalec, Lake Orion, MI (US); Richard J. Kukucka, Ann Arbor, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/780,828

(22) Filed: Feb. 18, 2004

Related U.S. Application Data
(60) Provisional application No. 60/511,504, filed on Oct. 15, 2003.

(51) Int. Cl. G05D 1/00

(52) U.S. Cl. 701/35; 701/36; 701/1

(57) ABSTRACT

A programmable vehicle accessory service allows a user to configure vehicle accessories. The user enters configuration data at an application. The application may be located at a personal computer, laptop, mobile telephone, or other device. The configuration data is transmitted to a remotely located server or controller. The controller processes the configuration data and generates vehicle accessory parameters according to the configuration data. The controller transmits the parameters to a module located in the vehicle. The module converts the parameters to a proper vehicle bus communication format and adjusts vehicle accessories according to the parameters. Additionally, the controller may transmit the parameters to a user device such as a laptop, mobile telephone, or personal data assistant. The user uploads the parameters from the user device to the module.

### FIELD OF THE INVENTION

The present invention relates to vehicle accessories, and more particularly to vehicle accessory features that are customizable by a user.

### BACKGROUND OF THE INVENTION

Vehicles include a variety of accessories with multiple features. For example, vehicle accessories may include turn signals, warning signals, vehicle alarms, and automatic door locks. Each accessory may include features such as sounds or chimes and on/off conditions. For example, turn signals may be accompanied by an intermittent sound or chime. Other features may be optional, such as automatically locking doors of the vehicle while the vehicle is moving.

While many vehicle accessory features are predetermined by the manufacturer, other features may be adjustable. The user may prefer a particular turn signal chime over the default chime. Additionally, the user may prefer that the vehicle alarm is louder or quieter. The user may have certain vehicle features adjusted by the manufacturer or at a dealership. However, most features are not adjustable by the user.

### SUMMARY OF THE INVENTION

A programmable vehicle accessory service for a vehicle comprises an application that receives configuration data from a user. A controller remotely located from the vehicle receives the configuration data from the application and generates vehicle accessory parameters based on the configuration data. A module located in the vehicle receives the vehicle accessory parameters from the controller and adjusts vehicle accessories according to the vehicle accessory parameters.

In another aspect of the invention, a programmable vehicle accessory service for a vehicle comprises an application that receives configuration data from a user. A controller remotely located from the vehicle receives the configuration data from the application and generates vehicle accessory parameters based on the configuration data. A user device receives the vehicle accessory parameters from the controller. A module located in the vehicle receives the vehicle accessory parameters from the user device and adjusts vehicle accessories according to the vehicle accessory parameters.

In another aspect of the invention, a method for customizing vehicle accessory features in a vehicle comprises receiving configuration data from a user at an application. The configuration data is transmitted to a controller that is remotely located from the vehicle. Vehicle accessory parameters are generated according to the configuration data at the controller. The vehicle accessory parameters are transmitted to a module in the vehicle. Vehicle accessories are adjusted according to the vehicle accessory parameters at the module.

In another aspect of the invention, a method for customizing vehicle accessory features in a vehicle comprises receiving configuration data from a user at an application. The configuration data is transmitted to a controller that is remotely located from the vehicle. Vehicle accessory parameters are generated according to the configuration data at the controller. The vehicle accessory parameters are transmitted to a user device. The vehicle accessory parameters are uploaded from the user device to a module in the vehicle. Vehicle accessories are adjusted according to the vehicle accessory parameters at the module.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a functional block diagram of a programmable vehicle accessory service according to the present invention;

FIG. 2 is a functional block diagram of a programmable vehicle accessory service including a wireless network according to the present invention;

FIG. 3 is a functional block diagram of an alternative embodiment of a programmable vehicle accessory service according to the present invention; and

FIG. 4 is a flow diagram of a programmable vehicle accessory service according to the present invention.

### DETAILED DESCRIPTION OF THE PREFERRED EMBODIMENTS

The following description of the preferred embodiment(s) is merely exemplary in nature and is in no way intended to limit the invention, its application, or uses.

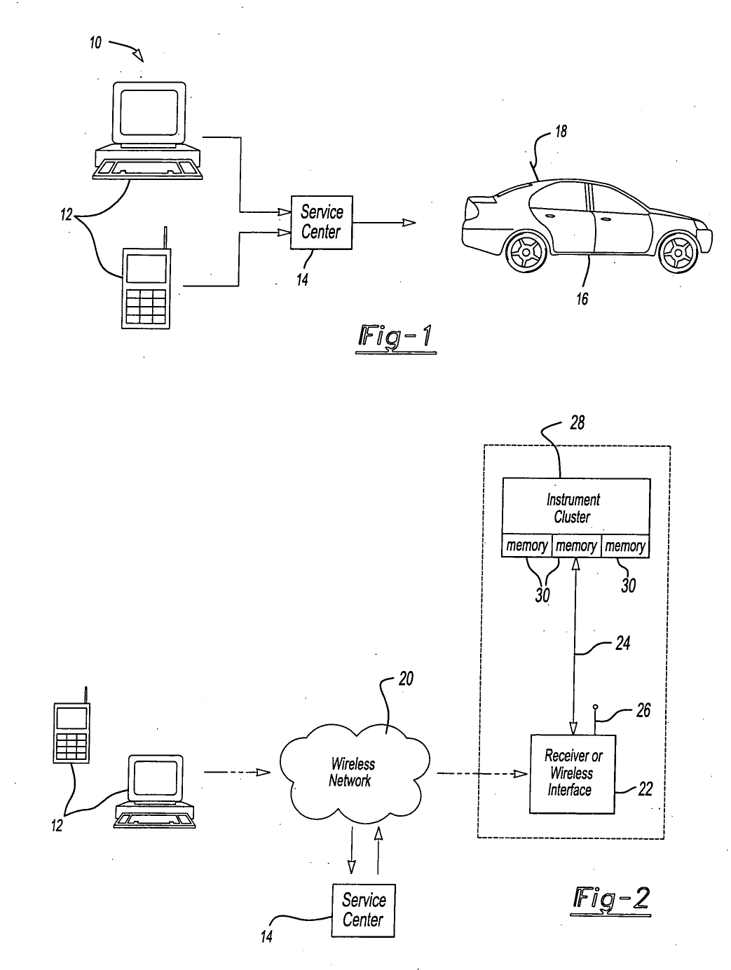

A programmable vehicle accessory service 10 includes a user application 12, a remote service center 14, and a vehicle 16 as shown in FIG. 1. In the preferred embodiment, the user application 12 is a software application on a computer network or mobile device. For example, the user application 12 may be a text-based or graphical user interface located at an Internet site. Alternatively, the user application 12 may be located on a laptop, mobile phone, personal data assistant, or other mobile device. A user enters configuration data at the user application 12. The configuration data is used to adjust features of specific vehicle accessories. For example, the user may configure characteristics of a horn, such as pitch, door locking behavior, vehicle alarm settings, or other vehicle features. The user may enter the configuration data using drop-down boxes, selectable buttons, or other suitable methods. However, the user application 12 and its interface may be implemented using a variety of methods as are known in the art.

The user application 12 may inherently restrict the degree of configuration available to the user. In other words, the user may only be able to adjust certain features within limits established by a manufacturer. For example, the user application 12 may allow the user to configure headlight intensity, but not exceed a minimum or maximum intensity. In other embodiments, the user application 12 may allow the user to fully customize a vehicle feature. One such feature involves vehicle features that may be accompanied by a sound or chime. For example, turning signals or warnings such as “door ajar” or “low fuel” may be accompanied by a continuous or intermittent sound. The user may wish to configure the type of sound, or completely eliminate the sound. Additionally, the user may upload an audio file to be used as the sound. The user uploads the audio file using the user application 12. The audio file may be a .wav file, an .mp3 file, or any other suitable format.

After the user enters the configuration data or audio file into the user application 12, the data is transmitted from the user application 12 to the remote service center 14. The configuration data may be transmitted wirelessly, via the Internet, or using other suitable methods. The service center 14 processes the configuration data according to the type of data that the user entered. If the user uploaded an audio file, the service center 14 may compress or convert the audio file into a different format. The service center 14 communicates the processed data wirelessly to the vehicle 16. The vehicle 16 receives the data at an antenna 18 or other module.

A detailed embodiment of the programmable vehicle accessory service is shown in FIG. 2. The user enters the configuration data at the user application 12. The configuration data is communicated to the service center 14. The configuration data is communicated over a wireless network 20 to the service center 14. In the preferred embodiment, an audio file is communicated to the service center 14. The service center 14 processes the data accordingly. For example, the service center 14 may convert the data to a format that is suitable for the user's vehicle. Additionally, the service center 14 may compress an audio file to a size that is more easily transmitted to or stored at the vehicle. The service center 14 transmits the data to a receiver module 22 located on the vehicle. The service center 14 may transmit the data over the wireless network 20 or by other suitable methods.

The receiver module 22 is an interface between the service center 14 and a vehicle data bus 24. The receiver module 22 converts the data from a wireless format to a format suitable for the data bus 24. For example, the data bus 24 may be a CAN-B format. The receiver module 22 may include an antenna 26 for receiving the data. In one embodiment, the receiver module 22 is a hands-free module for a mobile phone or other device. The receiver module 22 communicates the data to vehicle accessories, such as an instrument cluster 28, over the data bus 24. The instrument cluster 28 stores the data as configuration data for corresponding accessories. For example, if the user uploaded an audio file to be used as a turn signal sound at the user application 12, the instrument cluster 28 stores corresponding audio data for the turn signal. The instrument cluster 28 stores the audio data or configuration data in a memory module 30. The memory module 30 may be located within the instrument cluster 28, within each particular accessory, or any other suitable location.

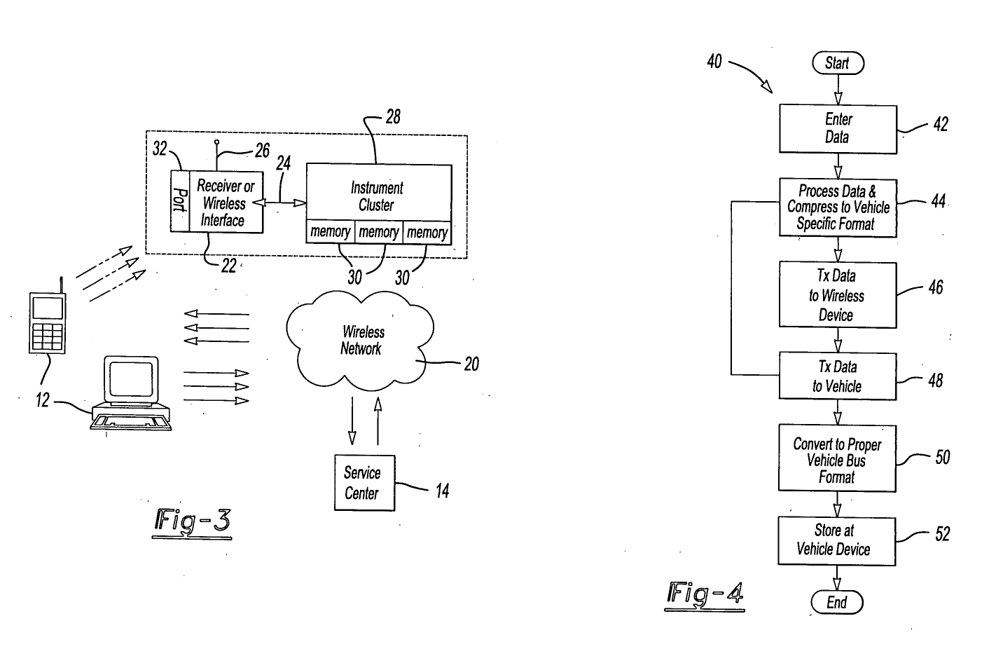

Another embodiment of the programmable vehicle accessory service is shown in FIG. 3. The user enters configuration data at the user application 12. The configuration data is transmitted to the service center 14 over the wireless network 20. The configuration data is processed at the service center 14 and transmitted back to user application 12. In other words, the configuration data may be downloaded to the user's laptop, PDA, mobile phone, or other device in a suitable format. The user then uploads the configuration data from the device to the receiver module 22. In one embodiment, the receiver module 22 includes a Bluetooth wireless port 32. The device communicates the configuration data wirelessly to the receiver module 22 in a Bluetooth data format. The receiver module 22 converts the Bluetooth data into CAN-B data for communication over the data bus 24.

FIG. 4 illustrates the programmable vehicle accessory process 40. The user enters configuration data at step 42. The configuration data is transmitted to a remote service center and processed at step 44. After the configuration data is processed, the service center transmits the configuration data to the user at a device such as a laptop, PDA, or mobile phone at step 46. The user uploads the configuration data to the vehicle at step 48. Alternatively, the service center may transmit the configuration data directly to the vehicle at step 48. After the vehicle receives the configuration data, the configuration data is converted to a suitable format for data bus communication at step 50. The configuration data is stored and used to adjust vehicle accessories at step 52.

The description of the invention is merely exemplary in nature and, thus, variations that do not depart from the gist of the invention are intended to be within the scope of the invention. Such variations are not to be regarded as a departure from the spirit and scope of the invention.

1. A programmable vehicle accessory service for a vehicle comprising:
an application that receives configuration data from a user;
a controller remotely located from the vehicle that receives the configuration data from the application and generates vehicle accessory parameters based on the configuration data; and
a module located in the vehicle that receives the vehicle accessory parameters from the controller and adjusts vehicle accessories according to the vehicle accessory parameters.

2. The service according to claim 1 wherein the application is located on at least one of an Internet site, a laptop, a mobile phone, and a personal data assistant.

3. The service according to claim 1 wherein the configuration data defines preferences of the user.

4. The service according to claim 1 wherein the configuration data is audio data.

5. The service according to claim 4 wherein the controller compresses the audio data.

6. The service according to claim 4 wherein the module adjusts a turn signal sound according to the audio data.

7. A programmable vehicle accessory service for a vehicle comprising:
an application that receives configuration data from a user;
a controller remotely located from the vehicle that receives the configuration data from the application and generates vehicle accessory parameters based on the configuration data;
a user device that receives the vehicle accessory parameters from the controller; and
a module located in the vehicle that receives the vehicle accessory parameters from the user device and adjusts vehicle accessories according to the vehicle accessory parameters.

8. The service according to claim 7 wherein the application is located on at least one of an Internet site, a laptop, a mobile phone, and a personal data assistant.

9. The service according to claim 7 wherein the configuration data defines preferences of the user.

10. The service according to claim 7 wherein the configuration data is audio data.

11. The service according to claim 10 wherein the controller compresses the audio data.

12. The service according to claim 10 wherein the module adjusts a turn signal sound according to the audio data.

13. The service according to claim 7 wherein the user device is at least one of a laptop, a mobile phone, and a personal data assistant.

14. A method for customizing vehicle accessory features in a vehicle comprising:
receiving configuration data from a user at an application;
transmitting the configuration data to a controller that is remotely located from the vehicle;
generating vehicle accessory parameters according to the configuration data at the controller;
transmitting the vehicle accessory parameters to a module in the vehicle; and
adjusting vehicle accessories according to the vehicle accessory parameters at the module.

15. A method for customizing vehicle accessory features in a vehicle comprising:
receiving configuration data from a user at an application;
transmitting the configuration data to a controller that is remotely located from the vehicle;
generating vehicle accessory parameters according to the configuration data at the controller;
transmitting the vehicle accessory parameters to a user device;
uploading the vehicle accessory parameters from the user device to a module in the vehicle; and
adjusting vehicle accessories according to the vehicle accessory parameters at the module.
